(19) United States
(12) Patent Application Publication
(10) Pub. No.: US 2011/0280265 A1
(43) Pub. Date: Nov. 17, 2011

(54) DRIVER CIRCUIT FOR THE DIRECT MODULATION OF A LASER DIODE

(75) Inventors: Louis Desbiens, St-Augustin-de-Desmaures (CA); Francois Duchesne, Quebec (CA); Michel Jacob, Quebec (CA); Bruno Labranche, Quebec (CA); Vincent Roy, Quebec (CA)

(73) Assignee: Institut National D'Optique, Quebec (CA)

(21) Appl. No.: 12/780,556

(22) Filed: May 14, 2010

(51) Int. Cl. H01S 3/10; H01S 3/00

(52) U.S. Cl. 372/38.02

(57) ABSTRACT

A driver circuit for a laser diode provides drive signals to the electrodes of the laser diode based on a pulsed input signal. An input receives the pulsed input signal and launches it into an amplification stage which preferably includes dual amplifiers, a buffering stage and a biasing stage. The output of the laser diode is an optical signal that reproduces the pulsed input signal with high fidelity and low amplitude noise. In one embodiment, the input separates the pulsed input signal into two signal components, launched in respective inverting and non-inverting branches which each include successive amplification, buffering and biasing stages.

### FIELD OF THE INVENTION

The present invention relates to the field of laser diodes and more particularly concerns a driver circuit for driving a laser diode based on a pulsing input signal.

### BACKGROUND OF THE INVENTION

Seeding a pulsed fiber laser oscillator with a directly modulated laser diode is a simple and cost-effective way of generating high energy, high peak power optical pulses with high stability. In material processing applications where a single pulse is used to process a given structure, such as severing links for memory repair, it is important to keep the pulse energy within a predetermined range. If the pulse energy is too low, then the link could be only partially fused, whereas if the energy is too high the substrate can be damaged, leading to failure mechanisms. It is therefore highly desirable to have optical pulses that have very high energy and amplitude stability. In a MOPA configuration (Master Oscillator Power Amplifier), as any undesirable features present at the seed level will be amplified, it is consequently of very high interest to have methods for pulsing a laser diode in a very predictable and repeatable way when seeding a first fiber amplifier section, so as to form what is generally called a Master Oscillator. The light from the Master Oscillator can be further amplified in a power amplifier which can be based on a large mode area doped fiber, or made of a solid state material such as a Nd:YVO₄ rod.

Optical pulse shaping is also of great interest in material processing applications as it offers the ability to control how the energy is delivered to the target over time. Elaborate optical pulse shapes require a highly responsive optical shaping mechanism. It is also of great interest to have the ability to generate optical pulses with fast rise time as it allows sophisticated material processing techniques.

Having a scheme for generating stable optical pulses that can be spectrally tuned is also highly desirable as it allows, for example the matching of a pulsed fiber laser oscillator with a Nd:YVO₄ amplifier, which has a very narrow gain bandwidth centered around 1064.5 nm. Having the ability to tune continuously the seed laser emission wavelength on the peak gain of an amplifier or on peak efficiency of a frequency conversion apparatus improves significantly the stability and reliability of such a system.

DELADURANTAYE et al (see the international patent application published under no. WO2009/155712) teaches a versatile platform for generating pulse shaping signals adapted for such applications, as well as several laser oscillator configurations generating shaped laser pulses based on such pulse shaping signals. In some configurations, the pulse shaping signal may be used to modulate the current of a seed laser diode directly, so that the seed laser diode outputs the shaped laser pulses. Driving a laser diode with high-speed pulsed signals however represents a real challenge to electronics designers. For example, difficulties arise if one wants to drive a laser diode with a relatively high current around 1 A or more with very short rise time and fall time, in the range of 1 ns or less. At these speeds, difficulties such as parasitic inductance and capacitance effects greatly limit the performances of the circuit.

There is therefore a need for a driver circuit which allows the driving of a laser diode with a pulse shaping signal at a high current and with short rise and fall times.

### SUMMARY OF THE INVENTION

According to one aspect of the invention, there is provided a driver circuit for providing a driving signal to a laser diode based on a pulsed input signal. The driver circuit includes, successively:
a signal input receiving the pulsed input signal;
an amplification stage amplifying the pulsed input signal;
a buffering stage including a plurality of voltage buffers connected in parallel and a plurality of pre-emphasis circuits each provided at an output of a corresponding one of the voltage buffers; and
a biasing stage adding a biasing voltage to the pulsed input signal, thereby obtaining the driving signal.

In accordance with another aspect of the invention, there is provided a driver circuit for providing respective driving signals to an anode and a cathode of a laser diode based on a pulsed input signal.

The driver circuit first includes a signal input receiving the pulsed input signal and dividing the same into first and second input signal components. Inverting and non-inverting branches then each receive one of the first and second input signal components and output one of the driving signals.

Each branch includes, successively:
an amplification stage amplifying the corresponding input signal component, the amplification stage of the inverting branch inverting the corresponding input signal component;
a buffering stage including a plurality of voltage buffers connected in parallel and a plurality of pre-emphasis circuits each provided at an output of a corresponding one of the voltage buffers; and
a biasing stage adding a biasing voltage to the corresponding input signal component, thereby obtaining a corresponding one of the driving signals.

In a preferred embodiment, the amplification stage includes two serially connected high speed amplifiers.

Advantageously, embodiments of the present invention provide high-speed laser diode driving circuits which are capable of adapting the electric signal provided by a pattern generator, such as a low voltage signal transmitted in a coaxial cable with a typical impedance of 50Ω, to drive a laser diode. The output of the laser diode is an optical signal that reproduces the electric signal from the pattern generator with high fidelity and low amplitude noise.

Other features and advantages of the present invention will be better understood upon reading of preferred embodiments thereof with reference to the appended drawings.

### BRIEF DESCRIPTION OF THE DRAWINGS

FIG. 1A is a graph showing a pulse of an exemplary pulse shaping input signal used to drive a laser diode though a driving circuit according to an embodiment of the invention; FIG. 1B is a graph showing the resulting optical pulse outputted by the laser diode.

FIG. 2 is a schematic representation of a driver circuit according to an embodiment of the invention.

FIG. 3 illustrates the evolution of an exemplary pulse shaping signal through the driver circuit of FIG. 2.

FIG. 4 is a schematic representation of an optimized topology for the driver circuit of FIG. 2.

FIGS. 5A to 5D schematically illustrate the relationships between the pulsed input signal (FIG. 5A), the applied voltage (FIG. 5B) and output optical power (FIG. 5C) as a function of circulating current and the resulting optical pulse shape (FIG. 5D) for a typical laser diode.

### DESCRIPTION OF PREFERRED EMBODIMENTS

In accordance with one aspect of the present invention, there is provided a driver circuit for providing driving signals to a laser diode, based on a pulsed input signal.

Preferred embodiments of the invention are particularly adapted for the driving of a high-speed laser diode, such as used for microprocessing applications and the like. The expression “laser diode” is understood to refer to a laser with a semiconductor-based gain media. The laser diode may for example be embodied by a 14-pin butterfly packaged diode such as used in the telecommunication industry, but other type of diodes may of course be considered, such as DFB (distributed feedback) laser diodes, DBR (distributed Bragg reflector) laser diodes, external cavity laser diodes with a short cavity (<1 cm) and a wavelength selective feedback element such as a small diffraction grating, for example, seeded Fabry-Perot short cavity laser diodes, Fabry-Perot short cavity laser diode with wavelength selective feedback, etc.

The expression “pulsed input signal” is understood to refer to an electrical signal of varying intensity and defining one or a succession of pulses. Each pulse preferably has a rise time, a fall time and a duration therebetween. In some embodiment, the pulsed input signal may be designed for so called “pulse shaping”, that is, the signal amplitude may vary over its duration, defining any desired pulse shape. The driving circuit according to embodiments of the invention preferably adapts this electric signal to drive a laser diode. The output of the laser diode is an optical signal that reproduces the pulsed input signal, preferably with high fidelity and low amplitude noise.

Laser diodes are usually low impedance devices above their conductive threshold. Furthermore, typical packages of laser diodes (such as the 14-pin butterfly package used in the telecommunication industry) are not necessarily optimised for high-speed modulation. As a consequence, the driver circuit according to embodiments of the invention incorporates appropriate circuitry for optimal impedance matching.

The pulsed input signal may originate from any appropriate pattern generator. For example, the pulsed input signal may be generated by a digital pulse shaping module such as described in U.S. patent application Ser. No. 12/493,949 (DELADURANTAYE et al.), the contents of which are incorporated herein by reference. The pulsed input signal may however originate from different pattern generators, such as the Tektronix AWG5000B or the Agilent 81180A. Typically, the pulsed input signal will have a low voltage, for example in the range of 0 to 2 V and be transmitted through a coaxial cable with a typical impedance of 50Ω.

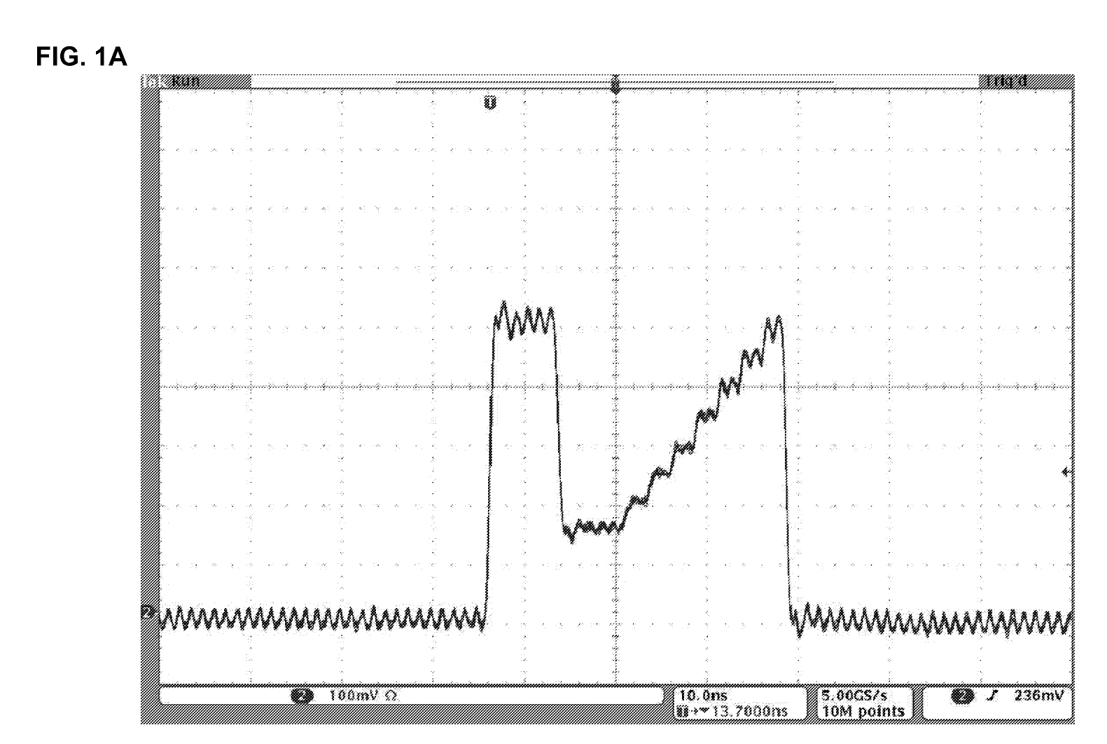

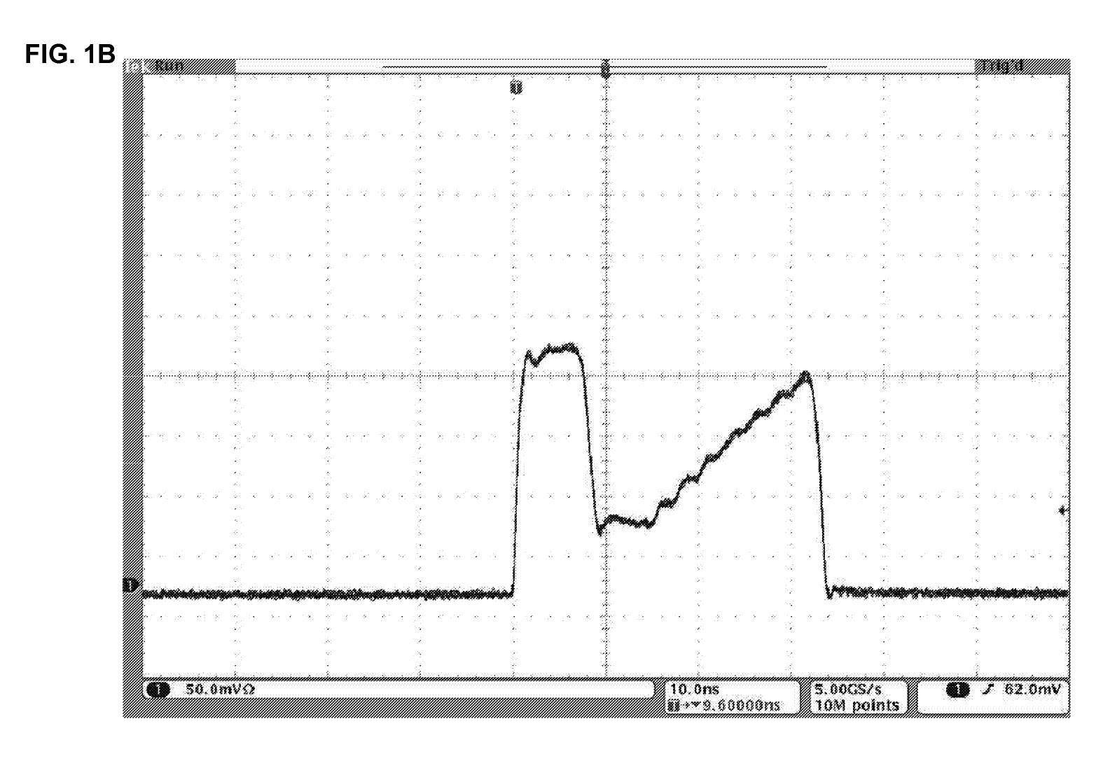

FIGS. 1A and 1B respectively show a pulse of an exemplary pulsed input signal used to drive a laser diode though a driving circuit according to an embodiment of the invention, and the resulting optical pulse outputted by the laser diode. In this example, the pulse repetition rate is 200 kHz and the pulse duration 32.5 ns. The electrical signal has a peak-to-peak amplitude of 500 mV into 50Ω. The optical signal was detected with a 2-GHz InGaAs photodiode. The peak power of the optical pulse is 250 mW and its center wavelength is 1064.5 nm.

Typical patterns of interest in material processing applications are pulses of duration varying from 1 nanosecond (ns) or less, to a few hundreds of nanoseconds at repetitions rates varying from single pulse to a few MHz. The pulses can have complex shapes and it is an advantageous feature of the laser diode driving circuit according to a preferred embodiment of the invention that it can reproduce complex electrical shapes. However, the invention may also be used in contexts where simpler pulse shapes (square or the like) are desired. The electric duty cycle of the signal to be reproduced is usually low, typically less than 10% (for example a signal composed of square-shaped 10-ns pulses at a repetition rate of 100 kHz will have a duty cycle of 0.1%).

For example, the bandwidth F_{C} [Hz] required for having a 1 ns rise time and fall time is given by the following formula:

F_{C}=0.35/rise time

A bandwidth of at least 350 MHz is therefore required. For this bandwidth, the detrimental effects of parasitic inductance become significant when the impedance due to this parasitic inductance is of the order of the resistance associated with the laser diode above its conductive threshold, which is around 1Ω for typical laser diodes used as seed sources:

|X_{P}|=R_{L}

Where |X_{P}| is the amplitude of the parasitic impedance and R_{L} [Ω] is the laser diode resistance.
By definition, we have:

|X_{P}|=2×π×F_{c}×Lₚ

Consequently:

L_{P}=R_{L}/(2×π×F_{C})

where L_{P} is the equivalent parasitic inductance that could limit the performances of a conventional circuit driving an ideal laser diode.

Using the numerical example above, one obtains:

L_{P}=0.45 nH

This inductance value is low compared to the realistic parasitic inductance of 4 nH associated with a laser diode mounted in a 14-pin butterfly package, which is a common package for fiber-pigtailed, single-mode laser diodes. For a 4-nH package inductance, an equivalent inductive impedance of 8.8Ω is then combined in series with the intrinsic resistive impedance of 1Ω of the laser diode.

In order to get a laser diode current of 1 A with a rise time of 1 ns or less, this higher impedance, and not only the laser diode resistance of 1Ω, must be taken into account. A higher voltage must therefore be applied to the laser diode very quickly in less than 1 ns. The embodiments of driver circuit described below allow this goal to be achieved.

Referring to FIG. 2 there is shown a driver circuit 20 according to a preferred embodiment of the invention.

The driver circuit includes a signal input 22 which receives the pulse shaping input signal 24 from an appropriate pattern generator (not shown). As mentioned above, the pulsed input signal 24 is typically transmitted over an input coaxial cable 25, and the signal input 22 therefore preferably includes a coaxial connector 26 and is impedance matched to the input coaxial cable 25 (50Ω impedance in the preferred embodiment).

In the illustrated embodiment, the pulsed input signal 24 is divided into first and second input signal components 28 and 30, respectively received into one of an inverting branch 32 and a non-inverting branch 34. Each branch 32, 34 outputs one of the driving signals 36 and 38 to a cathode 42 and an anode 40 of a laser diode 44. However, it will be understood that in other embodiments the driver circuit 20 may include only one branch, providing a same driving signal to the cathode 42 or the anode 40 of the laser diode 44 while the other electrode is maintained to ground level.

Each of the inverting and non-inverting branches 32 and 34 include the following stages, successively:

1) an amplification stage 46 amplifying the corresponding input signal component.

As their names entail, the amplification stage 46 of the inverting branch 32 inverts the corresponding input signal component 28, while the amplification stage 46 of the non-inverting branch is non-inverting. Preferably, the amplification stage 46 of each branch includes first and second serially connected high speed amplifiers 48 and 50. Providing two sub-stages of amplification may advantageously avoid a degradation of the rise and fall times caused by the gain-bandwidth limitation of the amplifiers 48 and 50. In this manner, the fastest rise times and fall times achievable with these high-speed amplifiers can be obtained. In other embodiments, three or more amplifiers per branch may be provided. In a given branch 32 or 34, the amplifiers 48 and 50 may be identical or dissimilar.

Further preferably, the second amplifier 50 of the inverting branch 32 performs the signal inversion. By “inversion” of the signal, it is understood that the voltages in both branches 32 and 34 have the same magnitude but opposed signs.

The amplifiers 48 and 50 may for example be embodied by Texas Instruments THS3202 chips. In the illustrated embodiment, the voltage gains are respectively 5 and 5.5 for the two stages.

2) a buffering stage 52.

The buffering stage 52 of each branch 32, 34 includes a plurality of voltage buffers 54 connected in parallel, in order to increase the current drive capacity, for example up to 1 A in the preferred embodiment. Voltage buffers are used to transfer a voltage from a high output impedance circuitry to a low input impedance circuitry. Devices suitable for this use are for example the buffers model BUF602 available from Texas Instruments. The number of voltage buffers 54 set in parallel depends on the targeted injection current to the laser diode 44. A significant degradation of the pulse rise and fall times can occur if the output current per buffer is over 200 mA for this particular buffer model. In such an embodiment, obtaining the desired current of 1 A within 1 ns may requires six or more buffers 54 per branch 32 and 34.

A plurality of pre-emphasis circuits 56 is also provided, each pre-emphasis circuit 56 being connected serially at the output of a corresponding voltage buffer 54. The role of each pre-emphasis circuit 56 is to allow momentarily the application of the full voltage available from the output of each voltage buffer 54 to the laser diode electrodes (anode 40 and cathode 42). This ‘pre-emphasis’ circuit is preferably a differentiating RC circuit that produces positive or negative overshoots at each transition in the pulse shaping input signal. Each pre-emphasis circuit 56 therefore includes a capacitor 58 and a resistor 60 connected in parallel. The values of the resistor 60 and capacitor 58 are trimmed as functions of the overall parasitic inductance of the laser diode 44, the number of voltage buffers 54 and the targeted current value injected in the laser diode 44. Typical values for the resistance and the capacitance are 62Ω and 5.6 pF for a two banks of six buffers configuration.

The outputs of all the pre-emphasis circuits 56 of a given branch 32 or 34 are then combined and the resulting signal forwarded to the next stage.

3) a biasing stage 62 adding a biasing voltage 64 to the corresponding input signal component.

In the preferred embodiment, the driver circuit 20 includes a bias input 66 receiving the biasing voltage 64 and dividing this bias voltage 64 into first and second biasing voltage components 68 and 70. The bias voltage is selected to properly bias the laser diode 44, and is typically adjusted around the conductive threshold of the laser diode 44 and below the lasing threshold voltage of the laser diode 44. In the preferred embodiment, the biasing voltage 64 is embodied by a DC voltage of the order of 1 V.

The biasing stage 62 of each branch 32 and 34 is in turn provided with a bias-T circuit 72 coupling one of the first and second biasing voltage components 68 and 70 to the corresponding branch 32 or 34. As one skilled in the art will readily understand, a bias-T circuit is typically composed of a low-inductance capacitor 74 connected in parallel with an inductor 76. The Bias-T circuits 72 mainly serve two purposes: they are used as high-pass filters for the application of the high-speed input signal components 28 and 30 as outputted by the buffering stage 52, and they are used as low-pass filters for the application of the DC biasing voltage 64.

As one skilled in the art will also understand, the simultaneous application of the pulsed input signal 24 to the anode 40 of the laser diode and of an inverted version of this same signal to the cathode 42 provides for a differential driving of the laser diode 44. The main advantage of using a differential driving circuit is to double the maximum voltage range of the voltage buffers 54. However, in embodiments where this doubling of the maximum voltage range is not necessary, a single branch may be provided without departing from the scope of the present invention.

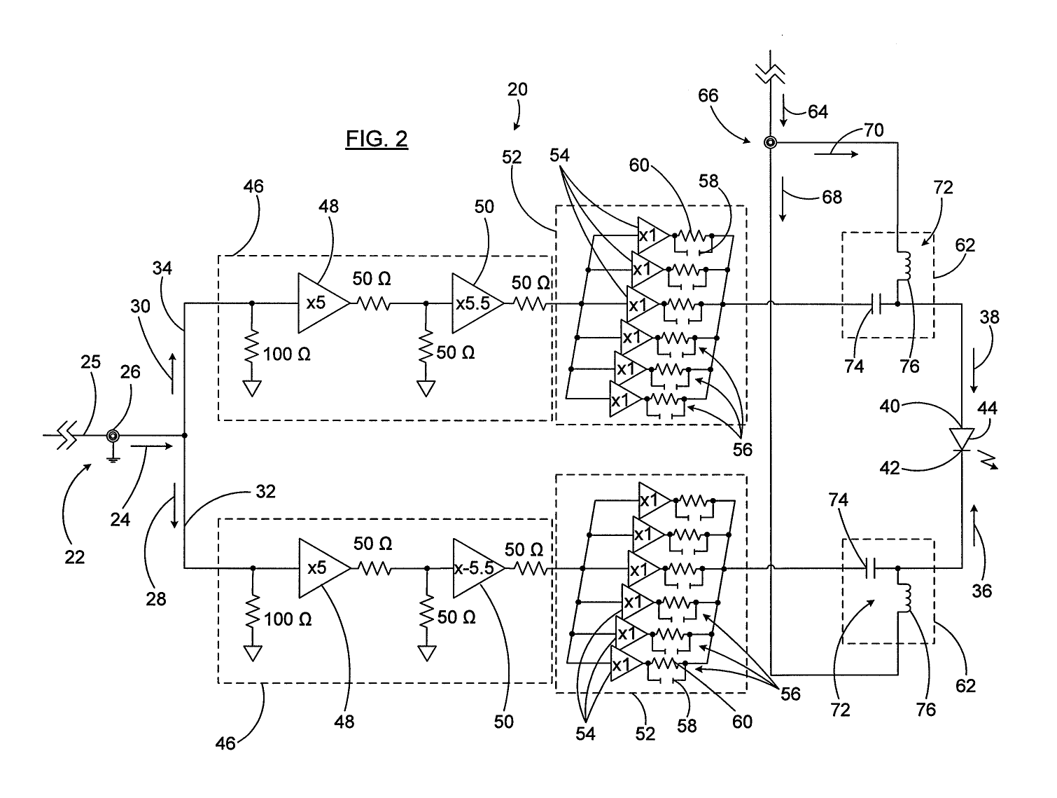

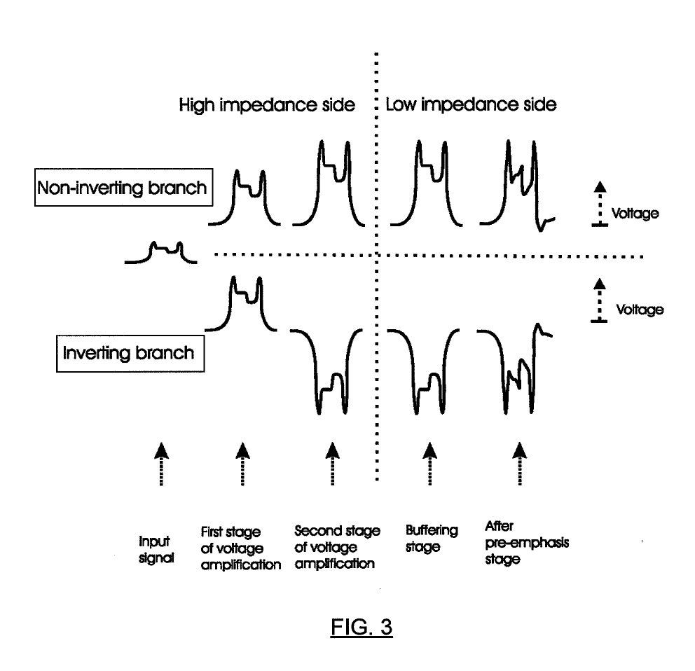

FIG. 3 illustrates the evolution of an exemplary pulse shaping signal at each of the stage of the driver circuit according to the illustrated embodiment of FIG. 2. In the first stage of voltage amplification, each component of the pulsed input signal is amplified in a linear fashion in both branches of the circuit. In the second stage of voltage amplification, the input signal components are further amplified; in the non-inverting branch the voltage sign is identical to that of the pulsed input signal, whereas in the inverting branch, the second stage of amplification inverts the sign of the corresponding input signal component.

The buffering stage has a voltage gain of 1 and does not affect the input signal components. The purpose of this stage is to increase the current driving capability of the circuit for driving a low impedance component such as a laser diode. After the pre-emphasis portion of the buffering stage, however the input signal components are slightly distorted, the transitions therein are more pronounced as positive and negatives overshoots having been generated by the differentiating RC circuits 56 for each of these transition.

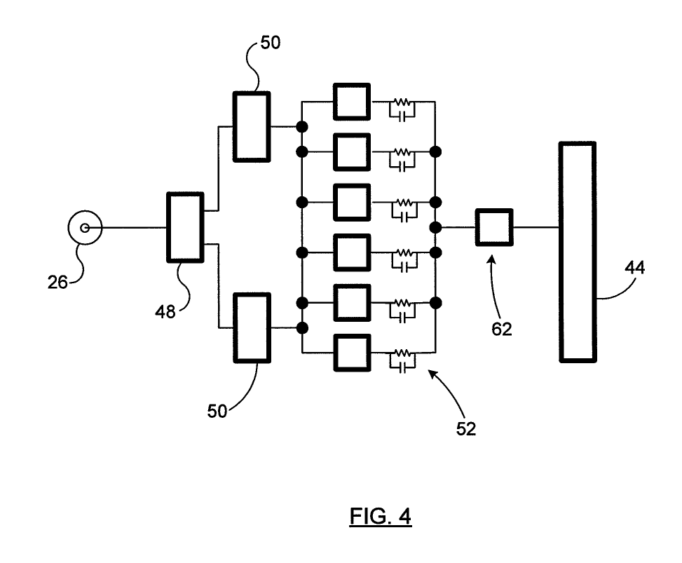

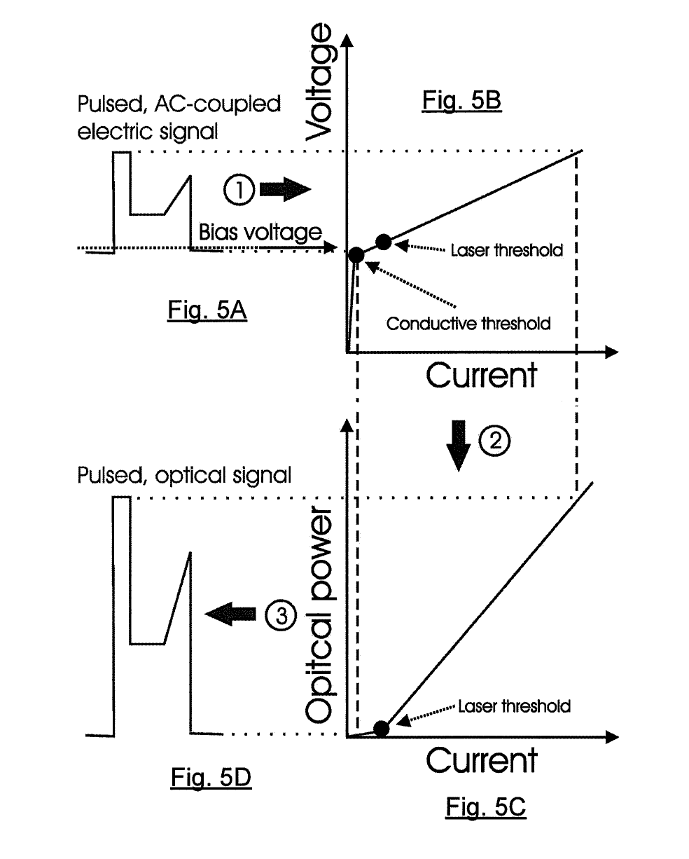

FIGS. 5A to 5D illustrates the relations between the bias voltage, the pulse shaping signal applied to the laser diode and how this voltage varying signal is converted to a shaped optical pulse in the laser diode. Referring to FIGS. 5A and 5B, the bias voltage is adjusted around the conductive threshold of the laser diode. The purpose of this bias is to bring the laser diode close but under its lasing threshold so as to operate the laser diode in a gain-switched type of operation. Without the bias voltage the high-speed driving circuit would have to provide the full voltage to bring the laser diode to its conductive threshold and above for optical emission, which may have a detrimental effect on the performances of the system. When the pulsed input signal is applied to the laser diode, the laser diode is brought rapidly above its laser threshold. If the laser cavity is short enough, the laser oscillation will quickly establish itself and provide fast rise time. Above the conductive threshold, the relation between the applied voltage and the associated circulating current in the laser diode is linear (see FIG. 5B). In the same manner, above the laser threshold, the relation between the circulating current and the emitted optical power is linear (see FIG. 5C). As a consequence, above the laser threshold, the emitted optical power is in linear relation with the applied voltage on the laser diode chip, the optical pulse (FIG. 5D) will follow the pulse shaping signal. Operating the laser diode in such a fashion, in a gain-switched regime, ensures that significant optical power will only be emitted when the pulsed input signal is present at the input of the circuit, and therefore limits the optical power emitted by the laser diode between successive pulses.

As one skilled in the art will readily understand, the transmission of the electrical pulsed input signal from the driving circuit to the laser diode chip may impact heavily on the performance of a tailored pulse shaping signal during fast transients. As described previously, the trimming of the ‘pre-emphasis’ circuit will help in compensating the parasitic inductance and capacitance related to the signal transmission. Further design elements which may help in that matter are:
minimizing the physical length over which the signal is transmitted between the drive circuit and the laser diode chip;
increasing the number of wires or the wire diameter for the wire bonding inside the laser diode package;
using stripline technology for transmission of the pulsed input signal to the laser diode chip;
reducing metal contacts areas on the laser diode chip for decreasing the laser chip capacitance; and
decreasing the length of the laser chip for decreasing its capacitance.

The parasitic inductance of the layout of the printed circuit board embodying the invention should preferably be reduced to a minimum for the electronic driver and the mounting of the laser diode. For those who are skilled in the art, the parasitic inductance of a printed circuit board trace is function of the trace length, width and the height of the trace over the ground plane. For example, a printed circuit board trace with a length of one inch (25.4 mm), a width of 10 mils of an inch (254 μm) and a height of 50 mils of an inch (1.27 mm) will have a parasitic inductance of 20.4 nH.

This value is five times the parasitic inductance of the laser diode case. In order to reduce this parasitic inductance under 1 nH, the parts placement and the printed circuit board trace layout are preferably optimized. An example of an optimized topology is shown in FIG. 4, where the first amplifier, the buffering stage and the biasing stage of the first and second branches, respectively, are superposed. All similar components of the inverting and non inverting branches are preferably top-and-bottom mounted, with the exception of the second amplifiers 50 (which is either inverting or non-inverting).

It will be readily understood by one skilled in the art that the present invention may be embodied by different devices, hardware, elements, combinations of elements or the like in different arrangements than shown in the appended drawings and described herein. Additional hardware may also be provided depending on the need of a particular application as is well known in the art.

Of course, numerous modifications could be made to the embodiments described above without departing from the scope of the present invention as defined in the appended claims.

1. A driver circuit for providing a driving signal to a laser diode based on a pulsed input signal, the driver circuit comprising, successively:
a signal input receiving the pulsed input signal;
an amplification stage amplifying the pulsed input signal;
a buffering stage comprising a plurality of voltage buffers connected in parallel and a plurality of pre-emphasis circuits each provided at an output of a corresponding one of said voltage buffers; and
a biasing stage adding a biasing voltage to the pulsed input signal, thereby obtaining said driving signal.

2. The driver circuit according to claim 1, wherein said signal input comprises a coaxial cable connector.

3. The driver circuit according to claim 1, wherein the amplification stage comprises first and second serially connected high speed amplifiers.

4. The driver circuit according to claim 1, wherein each of said pre-emphasis circuits comprises a capacitor and a resistor connected in parallel.

5. The driver circuit according to claim 1, wherein the buffering stage comprises at least six of said voltage buffers.

6. The driver circuit according to claim 1, wherein the biasing stage comprises a bias-T circuit.

7. A driver circuit for providing respective driving signals to an anode and a cathode of a laser diode based on a pulsed input signal, the driver circuit comprising:
a signal input receiving the pulsed input signal and dividing the same into first and second input signal components;
inverting and non-inverting branches, each receiving one of said first and second input signal components and outputting one of said driving signals, each of said branches comprising, successively;
an amplification stage amplifying the corresponding input signal component, the amplification stage of the inverting branch inverting said corresponding input signal component;
a buffering stage comprising a plurality of voltage buffers connected in parallel and a plurality of pre-emphasis circuits each provided at an output of a corresponding one of said voltage buffers; and
a biasing stage adding a biasing voltage to the corresponding input signal component, thereby obtaining a corresponding one of said driving signals.

8. The driver circuit according to claim 7, wherein said signal input comprises a coaxial cable connector.

9. The driver circuit according to claim 7, wherein the amplification stage of each branch comprises first and second serially connected high speed amplifiers.

10. The driver circuit according to claim 9, wherein the second amplifier of the amplification stage of the inverting branch performs said inverting of the corresponding input signal component.

11. The driver circuit according to claim 7, wherein each of said pre-emphasis circuits comprises a capacitor and a resistor connected in parallel.

12. The driver circuit according to claim 7, wherein the buffering stage of each of said branches comprises at least six of said voltage buffers.

13. The driver circuit according to claim 7, further comprising:
a bias input receiving the biasing voltage and dividing the same into first and
second biasing voltage component; and
wherein the biasing stage of each of said branches comprises a bias-T circuit coupling one of said first and second biasing voltage component to the corresponding one of said inverting and non-inverting branches.

14. The driver circuit according to claim 10, wherein the first amplifier, the buffering stage and the biasing stage of the first and second branches, respectively, are superposed.
